(19) United States
(12) Patent Application Publication
(10) Pub. No.: US 2025/0148273 A1
(43) Pub. Date: May 8, 2025

(54) SYSTEM AND METHOD FOR UTILIZING TRANSFORMER DEEP LEARNING BASED OUTLIER IC DETECTION

(71) Applicant: MEDIATEK INC., Hsinchu City (TW)

(72) Inventors: Khim Jun Koh, Hsinchu City (TW); Chi-Ming Lee, Hsinchu City (TW); Yi-Ju Ting, Hsinchu City (TW); Chung-Kai Chang, Hsinchu City (TW); Po-Chao Tsao, Hsinchu City (TW); Chin-Wei Lin, Hsinchu City (TW); Yu-Lin Yang, Hsinchu City (TW); Tung-Hsing Lee, Hsinchu City (TW); Chin-Tang Lai, Hsinchu City (TW)

(21) Appl. No.: 18/926,397

(22) Filed: Oct. 25, 2024

Related U.S. Application Data
(60) Provisional application No. 63/595,776, filed on Nov. 3, 2023.

(51) Int. Cl. G06N 3/0499

(52) U.S. Cl. CPC G06N 3/0499

(57) ABSTRACT

In an aspect of the disclosure, a method for detecting outlier integrated circuits on a wafer is provided. The method comprises: operating multiple test items for each IC on the wafer to generate measured values of the multiple test items for each IC; selecting a target IC and neighboring ICs on the wafer repeatedly. each time after selecting the target IC executes the following steps: selecting a measured value of the target IC as a target measured value and selecting measured values of the target IC and the neighboring ICs as feature values of the target IC and the neighboring ICs; executing a transformer deep learning model to generate a predicted value of the target measured value; and identifying outlier ICs according to the predicted values of all the target ICs and the corresponding target measured values of all the target ICs.

This application claims the benefit of U.S. provisional application Ser. No. 63/595,776, filed Nov. 3, 2023, the disclosure of which is incorporated by reference herein in its entirety.

### TECHNICAL FIELD

The disclosure relates in general to systems and methods for outlier detection, and more particularly, to techniques of systems and methods for utilizing transformer deep learning based outlier IC detection.

### BACKGROUND

Wafer testing is performed during IC production on every wafer and every silicon die. Otherwise, there could be defective semiconductor dies that will go through the assembly process and therefore lead to unnecessary expenses at the end of the manufacturing process. Conventional means for detecting reliability weak (outlier) ICs include wafer-level voltage stress test, dynamic part average testing (D-PAT), and nearest neighborhood residual (NNR). These methods have significant limitations. For example: the wafer-level voltage stress test is a method used in semiconductor manufacturing to detect potential defects on a wafer by applying higher-than-normal operating voltages to each chip. This method requires specialized equipment and time, increasing manufacturing cost; D-PAT is a univariate, model-free method that primarily calculates the mean and standard deviation of each test parameter to set dynamic thresholds, thereby detecting and screening out potential defective dies. This method ignores each test parameter is correlated with other parameter, thus this method is not accurate; NNR is also a model-free method that does not have learning parameters and can only calculate residuals by considering the local neighborhood measurement values of each die position. The accuracy of this method is also very low. Thus, there are needs for increasing the efficiency and accuracy of outlier ICs detection while maintaining low cost (without increasing the outlier IC screening ratio).

### SUMMARY

The present disclosure describes techniques for utilizing transformer deep learning based outlier IC detection.

The first aspect of the present disclosure features a method for detecting outlier integrated circuits (ICs) on a wafer. The method comprises operating a plurality of test items for each of a plurality of ICs on the wafer to generate measured values of the plurality of test items for each of the plurality of ICs The method also comprises selecting a target IC and neighboring ICs adjacent to the target IC, from the plurality of ICs on the wafer, repeatedly. Each time the target IC is selected, the following steps are executed: selecting a measured value from the measure values of the target IC as a target measured value and selecting measured values of the target IC and the neighboring ICs which are related to the target measured value as feature values of the target IC and the neighboring ICs; and executing a transformer deep learning model to generate a predicted value of the target measured value according to the feature values of the target IC and the neighboring ICs. The method also comprises identifying outlier ICs according to the predicted values of all the target ICs and the corresponding target measured values of all the target ICs after generating predicted values for all the target ICs.

The second aspect of the present disclosure features a system for detecting outlier ICs on a wafer. The system comprises an IC test module configured to operate a plurality of test items for each of a plurality of ICs on the wafer to generate measured values of the plurality of test items for each of the plurality of ICs. The system also comprises a target designating module configured to select a target IC and neighboring ICs adjacent to the target IC, from a plurality of ICs on the wafer repeatedly, and select a measured value from the measure values of the target IC as a target measured value and select measured values of the target IC and the neighboring ICs which are related to the target measured value as feature values of the target IC and the neighboring IC. A different target IC is selected at each time. The system also comprises a model execute module configured to execute a transformer deep learning model to generate a predicted value of the target measured value according to the feature values of the target IC and the neighboring ICs. The system also comprises a detecting module, configured to identify outlier ICs according to the predicted values of all the target ICs and the corresponding target measured values of all the target ICs after generating predicted values for all the target ICs.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a diagram illustrating a procedure of wafer sort utilizing an example system for deep learning based outlier detection, according to some implementations of the present disclosure.

FIG. 2A is a block diagram illustrating the system for detecting outlier ICs according to some implementations of the present disclosure.

FIG. 2B is a diagram illustrating an example operation of the transformer deep learning model of the system, according to some implementations of the present disclosure.

FIG. 2C is a distribution graph of the Mahalanobis distances of the target ICs of a wafer, according to some implementations of the present disclosure.

FIG. 3 includes graphs illustrating result comparisons between conventional means and deep learning based outlier detection according to some implementations of the present disclosure.

FIG. 4 is a flowchart of a process for detecting outlier ICs, according to some implementations of the present disclosure.

In the following detailed description, for purposes of explanation, numerous specific details are set forth in order to provide a thorough of understanding the disclosed implementations. It will be apparent, however, that one or more implementations may be practiced without these specific details. In other instances, well-known structures and devices are schematically shown in order to simplify the drawing.

### DETAILED DESCRIPTION

The following disclosure provides many different implementations, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include implementations in which the first and second features are formed in direct contact, and may also include implementations in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various implementations and/or configurations discussed.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various implementations given in this specification.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative implementations but, like the illustrative implementations, should not be used to limit the present disclosure. The elements included in the illustrations herein may not be drawn to scale.

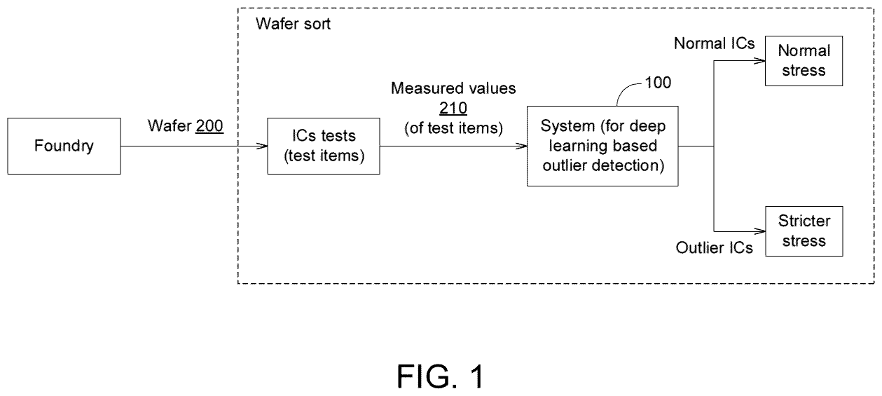

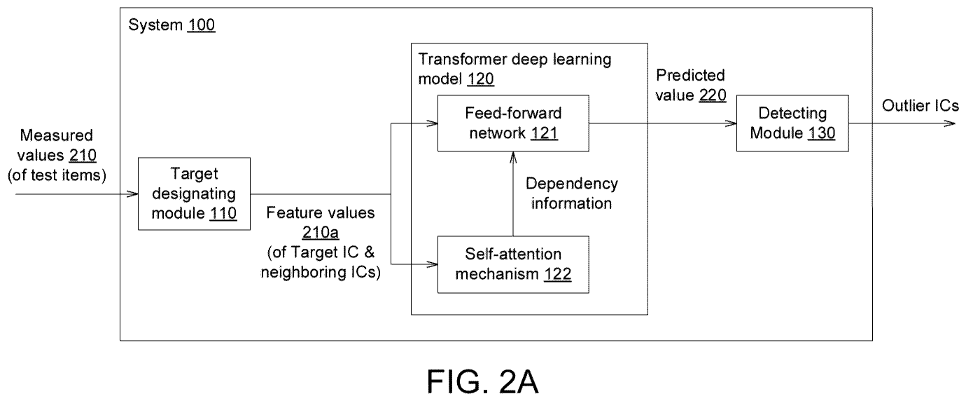

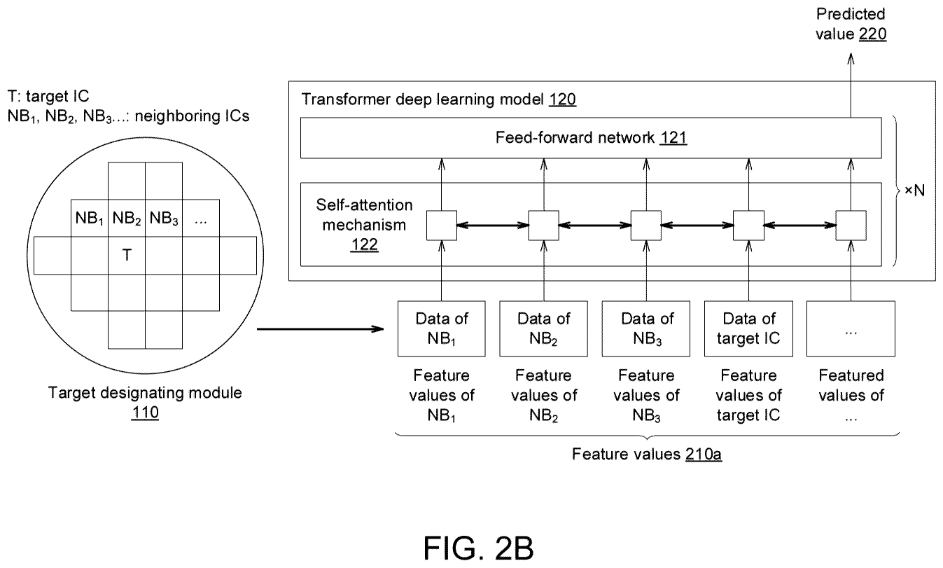

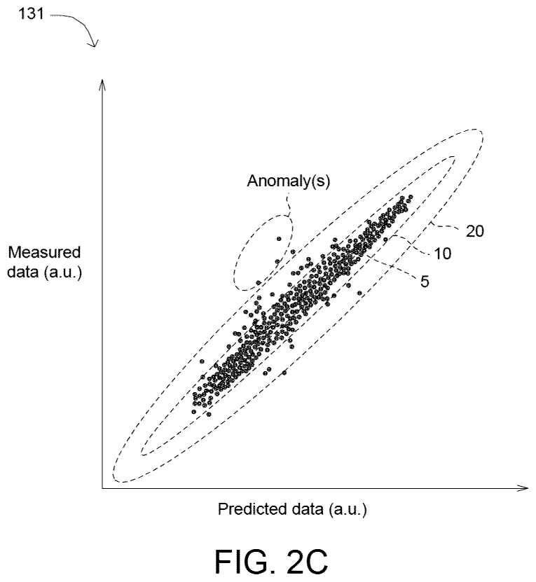

FIG. 1 is a diagram illustrating a procedure of wafer sort utilizing an example system 100 for deep learning based outlier detection, according to some implementations of the present disclosure. After wafer 200 is manufactured by the foundry, the wafer 200 would be applied with a wafer sort (or wafer test) process, which is a part of the testing process performed on silicon wafers, and includes IC test (or called Chip test). During the IC test, a plurality of tests are applied to a plurality of ICs on the wafer 200 according to a plurality of test items. Wafer sort's main purpose is to identify the outlier ICs (or non-functional dies) and thereby avoid assembly of those ICs (or dies) into packages. The types of test items during the IC test include current leakage (or IP leakage), minimum operating voltage (or IP Vmin), on-chip sensors, and each type further include a plurality of test items according to. In some implementations, the IC test process is operated by an IC test module. After the IC test, all ICs on the wafer 200 are tested through all test items, measured values (or called test values) 210 of the test items for all ICs on the wafer 200 are obtained, then the measured values 210 are used by a system 100 for deep learning-based outlier detection to identify and screen out ICs (outlier ICs) with potential reliability issues. To enhance the reliability and quality detection of ICs, the system 100 using a transformer deep learning model to ensure ICs with potential reliability issues are accurately identified and screened out. Then outlier ICs can undergo stricter stress test to confirm reliability. The system 100 applied with the techniques of deep learning-based outlier detection will be detailed described referring to FIGS. 2A to 2C as following.

FIG. 2A is a block diagram illustrating the system 100 according to some implementations of the present disclosure. The system 100 may comprise a target designating module 110, a transformer deep learning model 120 (which is executed on a model execute module) and a detecting module 130. As discussed above, after the IC test (or called chip test), the measured values 210 of the test items for all ICs on the wafer 200 are obtained. In the example of FIG. 2A, to detect outlier ICs, the target designating module 110 selects a target IC (or die) and neighboring ICs adjacent to the target IC repeatedly (each time, a different IC on the wafer is selected as target IC), selects a measured value of the target IC as a target measured value, and selects the measured values of the target IC and its neighboring ICs which are related to the target measured value as feature values. In some implementations, the feature values are selected according to a predetermined policy. For example, it is predetermined that some measured values of the target IC and its neighboring ICs have strong relationship with the target measured value, then these measured values of the target IC and its neighboring ICs can be selected as featured values of the target measured value. For another example, a table has been stored to record target measured values, feature values and their mapping relationship, so when a specific target measured value is selected, its corresponding feature values can be obtained by referencing the table. In this disclosure, the neighboring ICs of a target IC may be all or a subset of ICs on the wafer which excluding the target IC. In some implementations, the feature values of a target IC (or die) and its surrounding neighboring ICs can be organized into a 2-dimensional vector, the feature values of the target IC form a first dimension of the 2-dimensional vector and the feature values of all the neighboring ICs form a second dimension of the 2-dimensional vector. Then, for each target IC, the feature values of the target IC and its neighboring ICs (e.g., the 2-dimensional vector) can be received by the transformer deep learning model 120. In some implementations, the transformer deep learning model 120 includes a self-attention mechanism 122, which is configured for generating dependency information between a target IC and its neighboring ICs according to the feature values of the target IC and the feature values of the neighboring ICs, and a feed-forward network 121, which is configured for generating a predicted value of the target measured value of the target IC according to the dependency information. In other implementations, the transformer deep learning model 120 can only include the feed-forward network 121 to generate a predicted value for the target measured value of the target IC according to the feature values of the target IC and its neighboring ICs. The operations of the transformer deep learning model will be explained referring to FIG. 2B as following.

FIG. 2B is a diagram illustrating an example operation of the transformer deep learning model 120 of the system, according to some implementations of the present disclosure. After the target designating module 110 selects a target IC (or die), its neighboring ICs, the target measured value of the target IC, and the feature values of the target IC and its neighboring ICs, the feature values 210a of the target IC and the neighboring ICs can be received by the transformer deep learning model 120, as discussed above. For example, assuming that the number of ICs on the wafer is 20 (includes a target IC and 19 neighboring Ics), and the number of feature values of each IC for a target measured value is 100, thus the 100 feature values for each of the 20 ICs will be input into the transformer deep learning model 120 (for example, feature values 210a includes 100 feature values x 20 ICs).

Self-attention applied in the self-attention mechanism 122 is a mechanism in deep learning that enables the deep learning model to assess the importance of different parts of an input sequence when making predictions. Thus, for a target measured value, by inputting the feature values 210a into the self-attention mechanism 122, the dependency information between the feature values of the target IC and the feature values of each of the neighboring ICs can be obtained. As an example, the obtained dependency information may include: dependency information between a featured value of the target IC T and a corresponding featured value of its neighboring NB1, dependency information between the featured value of the target IC T and a corresponding featured value of its neighboring NB2, dependency information between the featured value of the target IC T and a corresponding featured value of its neighboring NB3, and so on. the dependency information indicates complex relationships among the target IC and its neighboring ICs.

With the dependency information generated by the self-attention mechanism 122, the feed-forward network 121 further obtain more complex, non-linear relationships between the feature values of the target IC and the corresponding feature values of each of the neighboring ICs, such as non-linear relationships between the feature values of the target IC and the corresponding feature values of NB1, non-linear relationships between the feature values of the target IC and the corresponding feature values of NB2, non-linear relationships between the feature values of the target IC and the corresponding feature values of NB3, and so on. When using the feed-forward network 121 after using the self-attention mechanism 122, allows for richer feature extraction and improved performance of the transformer deep learning model 120.

In some implementations, for each target IC, the self-attention mechanism 122 and the feed-forward network 121 can repeat the self-attention and feed-forward processes for N iterations (N is a positive integer), according to the feature values 210a, to keep updating the foresaid dependency information and the foresaid non-linear relationships. Each attention loop of the N iterations can focus on different aspects of the input (e.g., different feature values, different group of neighboring ICs), for updating the dependency information and the non-linear relationships. For example, in one attention loop of the N iterations, the self-attention mechanism 122 can focus on dependencies between the target IC and each of the neighboring ICs on the left side of the target IC for updating the dependency information, and the feed-forward network 121 can focus on learning non-linear relationships between the first 10 feature values of the 100 featured values within each IC. For another example, in another attention loop of the N iterations, the self-attention mechanism 122 can focus on dependencies between the target IC and each of the neighboring ICs on the upper side of the target IC for updating the dependency information, and the feed-forward network 121 can focus on learning non-linear relationships between the third 10 feature values of the 100 featured values within each IC.

After the foresaid operations, a predicted value 220 corresponding to the target measured value of a target IC can be generated by the feed-forward network 121. In some implementations, the predicted value 220 can be the final output of last one of the N iterations from the feed-forward network 121.

As mentioned before, the transformer deep learning model 120 can only include the feed-forward network 121 to generate a predicted value for a target measured value of a target IC according to the feature values of the target IC and its neighboring ICs. For a target measured value, by inputting the feature values 210a into the feed-forward network 121, the complex, the non-linear relationships between the feature values of the target IC and the corresponding feature values of each of the neighboring ICs can be obtained and a predicted value corresponding to the target measured value of the target IC can be generated accordingly. In FIG. 2B, the non-linear relationships may include: non-linear relationships between the feature values of the target IC and the corresponding feature values of NB1, non-linear relationships between the feature values of the target IC and the corresponding feature values of NB2, non-linear relationships between the feature values of the target IC and the corresponding feature values of NB3, and so on.

Referring back to FIG. 2A, after obtaining a plurality of predicted values for a plurality of target ICs, detecting module 130 identifies outlier ICs according to the predicted values of the target ICs and the corresponding target measured values of the target ICs. In some implementations, for each target IC, the detecting module 130 calculates a difference between the target predicted value of the target IC and the target measured value of the target IC, and identifies outlier IC(s) according to the differences of all the target ICs. For example, a target IC is identified as outlier IC if the difference between the target predicted value of the target IC and the target measured value of the target IC is larger than a predetermined threshold, and a target IC is identified as normal IC if the difference between the target predicted value of the target IC and the target measured value of the target IC is less or equal to a predetermined threshold. In some implementations, the detecting module 130 obtains a Mahalanobis distance for each target IC according to the predicted value 220 of the target IC and the target measured value of the target IC, and identifies outlier IC(s) according to the Mahalanobis distances of all the target ICs. How to use the Mahalanobis distances of all the target ICs to identify outlier IC(s) will be detailed described by referring to FIG. 2C as following.

FIG. 2C is a distribution graph 131 of the Mahalanobis distances of the target ICs of a wafer according to some implementations of the present disclosure, where each point on the graph represents a Mahalanobis distance corresponds to a target IC. For precise outlier identification, the Mahalanobis distances as shown in FIC. 2C are employed by the detecting module 130, to identify outliers (or called outlier ICs). When a Mahalanobis distance of a target IC occur at an outlier point outside a specified range (that is, expected ranges), 20 for example, in the graph 131, means an anomaly occurs, and the target IC can be determined as an outlier IC. In other case, when no anomaly of a target IC occurs (that is, the Mahalanobis distance of the target IC occur inside a specified range (that is, expected ranges), 20 for example), the target IC can be determined as a normal IC. By utilizing those techniques, data points that significantly deviate from the expected distribution can be accurately identified, thereby enhancing the precision of the anomaly detection process for identifying outlier ICs according to the techniques provided by the present disclosure.

In some implementations of this disclosure, before implementing the transformer deep learning model 120 in the wafer sort process, the transformer deep learning model 120 should undergo training. During the training stage, employs a standard Mean Squared Error (MSE) loss function. The MSE loss function optimizes the weights of the self-attention mechanism 122 and feed-forward network 121 by backpropagation to reduce data loss until the results converge. By using Backpropagation, the trained transformer deep learning model 120 can minimize the error between the actual output (such as a target measured value of a target IC) and the predicted output (such as a predicted value of the target IC).

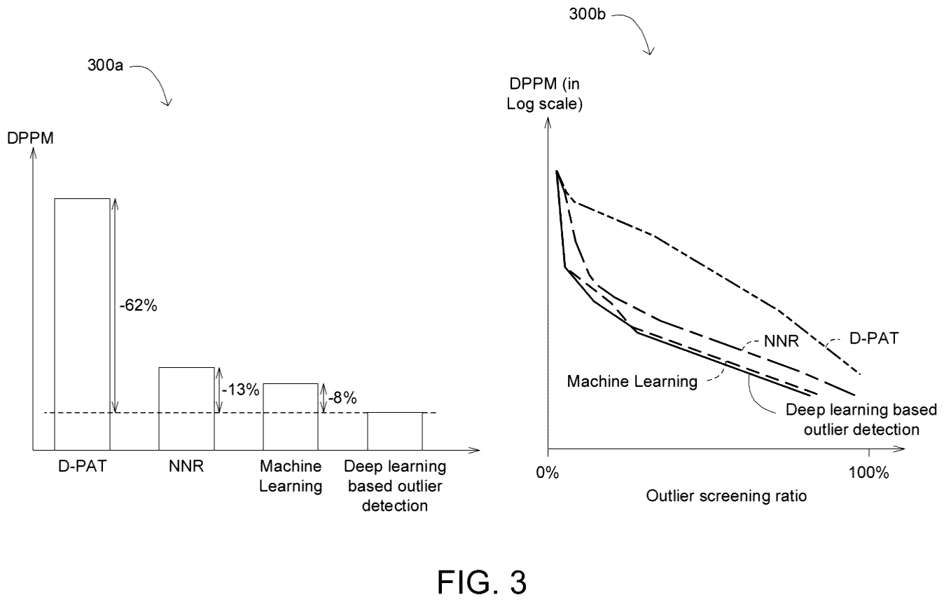

FIG. 3 includes graphs illustrating result comparisons 300a and 300b between conventional means (D-PAT, NNR, machine learning) and deep learning based outlier detection according to some implementations of the present disclosure. As shown in comparisons 300a, by applying the deep learning based outlier detection according to the present disclosure, comparing to conventional means, the defective parts per million (DPPM) can be decreased significantly. Also, as shown in comparisons 300b, by applying the deep learning based outlier detection according to the present disclosure, the DPPM can be decreased significantly without increasing much of the outlier screening ratio (from left to right), which means that, comparing to conventional means, more ICs can be retain while the DPPM of ICs decreasing. Thus, as shown by comparisons 300b, the efficiency of decreasing DPPM of ICs of the deep learning based outlier detection according to the present disclosure, and of Machine learning, NNR and D-PAT are sequentially from high to low.

As mentioned before, the wafer-level voltage stress test is a method used in semiconductor manufacturing to detect potential defects on a wafer by applying higher-than-normal operating voltages to each chip. This method requires specialized equipment and time, increasing manufacturing costs. However, the techniques provided by some implementations of the present disclosure utilize a transformer deep learning model and considers multi-dimensional data distributions (that is, both the feature values of the target ICs and their neighboring ICs), which doesn't need specialized equipment, and is cost-saving. Besides, the D-PAT is a univariate, model-free method that primarily calculates the mean and standard deviation of each test parameter to set dynamic thresholds, thereby detecting and screening out potential defective dies. This method ignores each test parameter is correlated with other parameter, which means this method is not accurate. However, the techniques provided by some implementations of the present disclosure utilize a transformer deep learning model and considers multi-dimensional data distributions (that is, both the feature values of the target ICs and their neighboring ICs), which has higher accuracy than the D-PAT method. Furthermore, the NNR is also a model-free method that does not have learning parameters and can only calculate residuals by considering the local neighborhood measurement values of each die position. The accuracy of this method is also very low. However, in this disclosure, utilizes a transformer deep learning model and considers multi-dimensional data distributions (that is, both the feature values of the target ICs and their neighboring ICs), which has higher accuracy than the NNR method. Moreover, the self-attention mechanism in this disclosure can interact each target IC's feature values with its neighboring ICs' feature values, thus the method of disclosure can capture more complex dependencies between ICs. Moreover, the Mahalanobis distances of the predicted values and measured values, helps in determining the precise outliers, ensuring that ICs with potential reliability issues are accurately identified and screened out. By keep selecting different target ICs and neighboring ICs within the same wafer or among wafers for applying the techniques provided by the present disclosure, the outlier detection accuracy will be enhanced, and DPPM will be decreased while maintaining low testing costs.

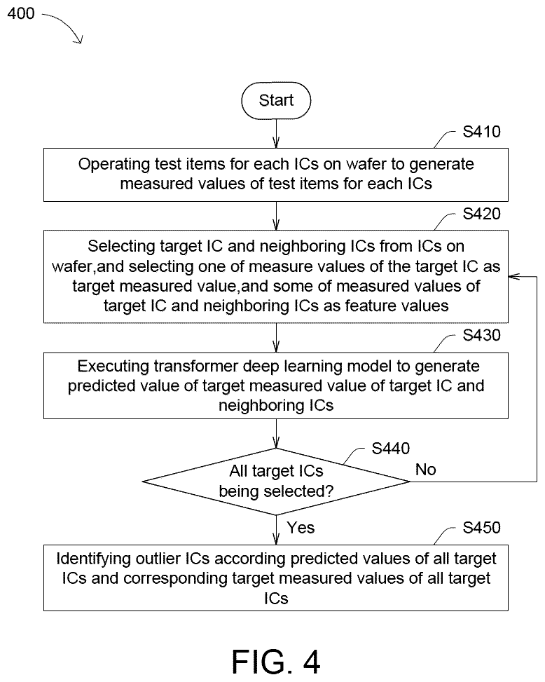

FIG. 4 is a flowchart of a process 400 for detecting outlier ICs, according to some implementations of the present disclosure.

In step S410, operating a plurality of test items for each IC on the wafer to generate measured values (or called test values) of the plurality of test items for each IC. In some implementations, the plurality of test items for each IC on the wafer are related to current leakage, minimum operating voltage, or on-chip sensors.

In step S420, selecting a target IC and neighboring ICs adjacent to the target IC, from a plurality of ICs on the wafer, and selecting one of the measure values of the target IC as a target measured value and selecting some of the measured values of the target IC and the neighboring ICs which are related to the target measured value as feature values. In some implementations, the neighboring ICs of the target IC are all or a subset of the plurality of ICs on the wafer but excluding the target IC.

In S430, executing a transformer deep learning model to generate a predicted value of the target measured value according to the feature values of the target IC and the neighboring ICs.

In some implementations, the feature values of the target IC and the neighboring ICs are received and processed by a feed-forward network of the transformer deep learning model to obtain non-linear relationships between the feature values of the target IC and corresponding feature values of each of the neighboring ICs, and the predicted value corresponding to the target measured value of the target IC is generated by the feed-forward network according to the non-linear relationships.

In some implementations, a self-attention mechanism of the transformer deep learning model is executed for obtaining dependency information between the target IC and the neighboring ICs according to the feature values of the target IC and the corresponding feature values of the neighboring ICs. With the dependency information, the feed-forward network of the transformer deep learning model is further executed to obtain more complex, non-linear relationships between the feature values of the target IC and the corresponding feature values of each of the neighboring ICs according to the dependency information, and the predicted value is generated according to the non-linear relationships.

In some implementations, executing the self-attention mechanism and the feed-forward network N iterations for the target IC. N is a positive integer, and each attention loop of the N iterations obtains different aspects of the dependency information and the non-linear relationships, from the feature values. In some implementations, the predicted value is a final output of last one of the N iterations from the feed-forward network. In some implementations, the transformer deep learning model is trained by employing a MSE loss function, to optimize weights of the self-attention mechanism and the feed-forward network by backpropagation, and thus minimizes errors between the target measured value of the target IC and the predicted value of the target IC.

In some implementations, before received by the transformer deep learning model, the feature values of the target IC and the neighboring ICs are organized into a 2-dimensional vector, wherein the feature values of the target IC form a first dimension of the 2-dimensional vector and the corresponding feature values of the neighboring ICs form a second dimension of the 2-dimensional vector.

In step S440, determining whether all target ICs have been selected, if yes, goes to step S450, otherwise goes to step S420. In some implementations, the target IC and the neighboring ICs adjacent to the target IC is repeatedly selected from the plurality of ICs on the wafer. For each time, a different IC on the wafer is selected as the target IC. In some implementations, the target measured value is repeatedly selected from the measured values of the target IC, and the feature values related to the selected target measured value are repeatedly selected from the measured values of the target IC and the neighboring ICs. For each time, a different target measured value of the target IC is selected.

In step S450, identifying outlier ICs according to the predicted values of all the target ICs and the corresponding target measured values of all the target ICs.

In some implementations, for each target IC, calculating a difference between the target predicted value of the target IC and the target measured value of the target IC, and identifies outlier IC(s) according to the differences of all the target ICs. For example, a target IC is identified as outlier IC if the difference between the target predicted value of the target IC and the target measured value of the target IC is larger than a predetermined threshold, and a target IC is identified as normal IC if the difference between the target predicted value of the target IC and the target measured value of the target IC is less or equal to a predetermined threshold.

In some implementations, obtaining a Mahalanobis distance for each target IC according to the predicted value of the target IC and the target measured value of the target IC, and identifies outlier IC(s) according to the Mahalanobis distances of all the target ICs. When a Mahalanobis distance of a target IC occur at an outlier point outside a specified range (that is, expected ranges), 20 for example, in the graph 131, means an anomaly occurs, and the target IC can be determined as an outlier IC. In other case, when no anomaly of a target IC occurs (that is, the Mahalanobis distance of the target IC occur Inside a predetermined specified range (that is, expected ranges), 20 for example), the target IC can be determined as a normal IC.

A system may encompass all apparatus, devices, and machines for processing data, including by way of example a programmable processor, a computer, or a plurality of processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software disclosure, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in a plurality of coordinated files (e.g., files that store one or more modules, sub programs, or portions of code). A computer program can be deployed for execution on one computer or on a plurality of computers that are located at one site or distributed across a plurality of sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors, processing units, engines, and accelerators suitable for the execution of a computer program include, by way of example, both general and special purpose microprocessors, and any one or more processors of any kind of digital computer. Generally, a processor, a processing unit, an engine, or an accelerator will receive instructions and data from a read only memory or a random access memory or both. The essential elements of a computer can include a processor, a processing unit, an engine, or an accelerator for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks. The processor, the processing unit, the engine, or the accelerator and the memory can be supplemented by, or incorporated in, special purpose logic circuitry, such as other processors, processing units, engines, or accelerators.

While this document may describe many specifics, these should not be construed as limitations on the scope of an invention that is claimed or of what may be claimed, but rather as descriptions of features specific to particular implementations. Certain features that are described in this document in the context of separate implementations can also be implemented in combination in a single embodiment. Conversely, various features that are described in the context of a single embodiment can also be implemented in a plurality of implementations separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made according to what is disclosed.

What is claimed is:

1. A method for detecting outlier integrated circuits (ICs) on a wafer, comprising:
operating a plurality of test items for each of a plurality of ICs on the wafer to generate measured values of the plurality of test items for each of the plurality of ICs;
selecting a target IC and neighboring ICs adjacent to the target IC from the plurality of ICs on the wafer, repeatedly, wherein each time the target IC is selected, the following steps are executed:
selecting a measured value from the measure values of the target IC as a target measured value and selecting measured values of the target IC and the neighboring ICs which are related to the target measured value as feature values of the target IC and the neighboring ICs; and
executing a transformer deep learning model to generate a predicted value of the target measured value according to the feature values of the target IC and the neighboring ICs; and
identifying outlier ICs according to the predicted values of all the target ICs and the corresponding target measured values of all the target ICs after generating predicted values for all the target ICs.

2. The method according to claim 1, wherein the step of executing a transformer deep learning model comprising:
obtaining by a feed-forward network of the transformer deep learning model, the non-linear relationships between the feature values of the target IC and corresponding feature values of each of the neighboring ICs; and
generating by a feed-forward network of the transformer deep learning model, a predicted value corresponding to the target measured value of the target IC according to the non-linear relationships.

3. The method according to claim 1, wherein the step of executing a transformer deep learning model comprising:
obtaining by a self-attention mechanism of the transformer deep learning model, dependency information between the target IC and the neighboring ICs according to the feature values of the target IC and the corresponding feature values of the neighboring ICs;
obtaining by a feed-forward network of the transformer deep learning model, the non-linear relationships between the feature values of the target IC and corresponding feature values of each of the neighboring ICs according to the dependency information; and
generating by the feed-forward network of the transformer deep learning model, a predicted value corresponding to the target measured value of the target IC according to the non-linear relationships.

4. The method according to claim 3, wherein for each target IC, the self-attention mechanism and the feed-forward network repeat N iterations to keep updating the dependency information and the non-linear relationships,
wherein N is a positive integer, and each attention loop of the N iterations focuses different aspects of the feature values or different group of neighboring ICs.

5. The method according to claim 4, wherein the predicted value is the final output of the last one of the N iterations from the feed-forward network.

6. The method according to claim 3, wherein before executing the transformer deep learning model, the transformer deep learning model is trained by employing a standard Mean Squared Error (MSE) loss function to optimize weights of the self-attention mechanism and the feed-forward network by backpropagation.

7. The method according to claim 1, wherein the plurality of test items for each of the plurality of ICs on the wafer are related to current leakage, minimum operating voltage, or on-chip sensors.

8. The method according to claim 1, wherein before executing a transformer deep learning model, the feature values of the target IC and the neighboring ICs are organized into a 2-dimensional vector, wherein the feature values of the target IC form a first dimension of the 2-dimensional vector and the corresponding feature values of the neighboring ICs form a second dimension of the 2-dimensional vector.

9. The method according to claim 1, wherein the neighboring ICs of the target IC are all or a subset of the plurality of ICs excluding the target IC, on the wafer.

10. The method according to claim 1, wherein the step of identifying outlier ICs comprising:
obtaining a Mahalanobis distance for each target IC according to the predicted value of the target IC and the target measured value of the target IC, and identifying outlier IC(s) according to the Mahalanobis distances of all the target ICs.

11. The method according to claim 10, wherein the step of identifying outlier IC(s) according to the Mahalanobis distances of all the target ICs, further comprising:
Identifying the target IC as an outlier IC when the Mahalanobis distance of the target IC occurs at an outlier point outside a predetermined specified range; and
Identifying the target IC as a normal IC when the Mahalanobis distance of the target IC occurs inside the predetermined specified range.

12. A system for detecting outlier ICs on a wafer, comprising:
an IC test module, configured to operate a plurality of test items for each of a plurality of ICs on the wafer to generate measured values of the plurality of test items for each of the plurality of ICs;
a target designating module, configured to select a target IC and neighboring ICs adjacent to the target IC, from a plurality of ICs on the wafer repeatedly, and select a measured value from the measure values of the target IC as a target measured value and select measured values of the target IC and the neighboring ICs which are related to the target measured value as feature values of the target IC and the neighboring IC, wherein a different target IC is selected at each time;
a model execute module, configured to execute a transformer deep learning model to generate a predicted value of the target measured value according to the feature values of the target IC and the neighboring ICs; and
a detecting module, configured to identify outlier ICs according to the predicted values of all the target ICs and the corresponding target measured values of all the target ICs after generating predicted values for all the target ICs.

13. The system according to claim 12, wherein when executing the transformer deep learning model, the model execute module is further configured to obtain by a feed-forward network of the transformer deep learning model, the non-linear relationships between the feature values of the target IC and corresponding feature values of each of the neighboring ICs, and generate by the feed-forward network of the transformer deep learning model, a predicted value corresponding to the target measured value of the target IC according to the non-linear relationships.

14. The system according to claim 12, wherein when executing the transformer deep learning model, the model execute module is further configured to:
obtain by a self-attention mechanism of the transformer deep learning model, dependency information between the target IC and the neighboring ICs according to the feature values of the target IC and the corresponding feature values of the neighboring ICs;
obtain by a feed-forward network of the transformer deep learning model, the non-linear relationships between the feature values of the target IC and corresponding feature values of each of the neighboring ICs according to the dependency information; and
generate by the feed-forward network of the transformer deep learning model, a predicted value corresponding to the target measured value of the target IC according to the non-linear relationships.

15. The system according to claim 14, wherein for each target IC, the self-attention mechanism and the feed-forward network repeat N iterations to keep updating the dependency information and the non-linear relationships,
wherein N is a positive integer, and each attention loop of the N iterations focuses different aspects of the feature values or different group of neighboring ICs;
wherein the predicted value is the final output of last one of the N iterations from the feed-forward network.

16. The system according to claim 14, further comprising:
a model training module, configured to train the transformer deep learning model by employing a standard Mean Squared Error (MSE) loss function to optimize weights of the self-attention mechanism and the feed-forward network by backpropagation.

17. The system according to claim 12, wherein the target designating module is further configured to organize the feature values of the target IC and the neighboring ICs into a 2-dimensional vector before the model execute module execute the transformer deep learning model, wherein the feature values of the target IC form a first dimension of the 2-dimensional vector and the corresponding feature values of the neighboring ICs form a second dimension of the 2-dimensional vector.

18. The system according to claim 12, wherein the neighboring ICs of the target IC are all or a subset of the plurality of ICs excluding the target IC, on the wafer.

19. The system according to claim 12, wherein when identifying outlier ICs according to the predicted values of all the target ICs and the corresponding target measured values of all the target ICs, the detecting module is further configured to:
obtain a Mahalanobis distance for each target IC according to the predicted value of the target IC and the target measured value of the target IC, and identify outlier IC(s) according to the Mahalanobis distances of all the target ICs.

20. The system according to claim 19, wherein when identifying outlier IC(s) according to the Mahalanobis distances of all the target ICs, the detecting module is further configured to:
identify the target IC as an outlier IC when the Mahalanobis distance of the target IC occurs at an outlier point outside a predetermined specified range; and
identify the target IC as a normal IC when the Mahalanobis distance of the target IC occurs inside the predetermined specified range.
